(19) United States
(12) Patent Application Publication
(10) Pub. No.: US 2026/0327426 A1
(43) Pub. Date: Oct. 22, 2026

(54) BASE MATERIAL FOR SILK FIBROIN MOLDED BODY AND THE MANUFACTURING METHOD

(71) Applicant: CANON VIRGINIA, INC., Newport News, VA (US)

(72) Inventors: Akira YANE, Shinagawa-ku (JP); Yu KAMENO, Yokohama (JP); Toshiyuki TOMITA, Yokohama (JP); Kota YAGI, Ohta-ku (JP); Koki KODAIRA, Ohta-ku (JP)

(21) Appl. No.: 19/105,661

(22) PCT Filed: Aug. 22, 2022
(86) PCT No.: PCT/US2022/075286

§ 371 Date: Feb. 21, 2025

(51) Int. Cl. C08L 89/00; B29C 43/00; C08H 1/00

(52) U.S. Cl. CPC C08L 89/00; B29C 43/003; B29C 43/006; C08H 1/00; B29K 2089/00; B29K 2995/007

(57) ABSTRACT

The present disclosure provides a base material for fibroin molding which can be easily molded without the labor of laminating, and a method for producing a fibroin molded body, wherein the base material for molding having silk fibroin as the main component, wherein the base material for molding has an bulk density of 0.7 g/cm³~1.2 g/cm³.

### FIELD OF THE DISCLOSURE

The present disclosure relates to a base material for molding silk fibroin and to its manufacturing method.

### BACKGROUND

International Patent Application Publication No. 2017/047503 provides a molded article obtained by filling a mold with a powder of a protein containing a natural spider silk protein which is silk fibroin or a polypeptide derived from a natural spider silk protein, and heating and pressurizing it.

### SUMMARY OF THE DISCLOSURE

When the powder of silk fibroin is used as the base material for the molded body, it easily scatters and adheres to the surroundings. Therefore, the problem was that filling of a stable amount to the mold was not possible, so the filling amount varied, and the dimensions of the molded body became unstable, or the surface shape of the mold was not sufficiently transferred because pressure was not applied to the silk fibroin inside the mold, due to the filling amount being insufficient, lowering the strength of the molded body.

The present disclosure provides a base material for silk fibroin molding which can be stably molded, and a method for producing a molded body of silk fibroin.

Specifically, the present disclosure provides a base material for molding that contains silk fibroin as a main component, wherein the bulk density is from about 0.70 g/cm³ to about 1.20 g/cm³. In one aspect, the base material has a thickness of about 100 μm or more. In another aspect, the base material has a β-sheet content of less than about 10%, and/or the moisture content is from about 2 to about 15%.

In a further aspect, the base material can have a cylindrical shape, a polygonal columnar shape, a spherical shape, or a hemispherical shape. A still further aspect provides a set of packaged base material for molding containing a plurality of pieces of the base material for molding that contains silk fibroin as a main component, and wherein the bulk density is from about 0.70 g/cm³ to about 1.20 g/cm³. A further aspect, the set of the base material includes a packing body consisting of paper, resin, rubber and metal.

In a still further aspect, there is provided a method for molding silk fibroin which comprises dispensing an aqueous solution of silk fibroin containing less than 10 g of silk fibroin, lyophilizing the solution, compressing the resulting lyophilized body until the bulk density becomes about 0.7 g/cm³ to about 1.20 g/cm³, and heating and pressurizing the compressed body.

In another aspect of the method of molding, the solid content in the dispensed aqueous solution is equal to or 1/N of the molded body's weight.

According to the present disclosure, since the silk fibroin is compressed until the bulk density becomes about 0.70 g/cm³ to about 1.20 g/cm³, compared to silk fibroin powder, scattering and adhering to the surroundings are suppressed, and the filling amount to the mold becomes consistent. Furthermore, since the filling amount is consistent, the dimensions of the molded body are consistent, the transferability of the mold shape of the molded body is improved, and the deterioration of the mechanical strength of the molded body is suppressed.

These and other embodiments, objects, features, and advantages of the present disclosure will become apparent upon reading the following detailed description of exemplary embodiments of the present disclosure, when taken in conjunction with the appended drawings, and provided claims.

### BRIEF DESCRIPTION OF THE DRAWINGS

The accompanying drawings, which are incorporated herein and form part of the specification, illustrate various embodiments, objects, features, and advantages of the present disclosure.

FIG. 1 is a schematic diagram of a mold for silk fibroin molding.

FIG. 2 is diagram depicting blocks for lyophilization.

FIG. 3A-B are diagrams showing cross-sections of the blocks for lyophilization in FIG. 2.

FIG. 4 is a diagram showing the components for a process for obtaining a base material for silk fibroin molding.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims. Furthermore, each embodiment described can be made or used in combination with any other described embodiment.

### DETAILED DESCRIPTION

The present disclosure has several embodiments and relies on patents, patent applications and other references for details known to those of the art. Therefore, when a patent, patent application, or other reference is cited or repeated herein, it should be understood that it is incorporated by reference in its entirety for all purposes as well as for the proposition that is recited.

The base material for the silk fibroin molded body of this embodiment contains silk fibroin and has a bulk density in a range from 0.70 g/cm³ to 1.20 g/cm³. The base material for molded body (base material for molding) is a base material used when a functional solid item having silk fibroin as the main material is molded into a desired shape.

By using that protein composition as base material for the molded body, the protein molded body of the present embodiment can be formed. Specifically, by adjusting the bulk density in the range from 0.70 g/cm³ to 1.20 g/cm³, scattering and adhesion are suppressed, since the base material for the silk fibroin molded body has the appropriate strength and weight.

Below, silk fibroin, adjustment of the bulk density, and molding will be described.

Silk Fibroin Silk fibroin is a fibrous protein that can be extracted from cocoons and/or nests.

The extraction of silk fibroin can be carried out, for example, by the method described in WO 2006/101223.

Silk fibroin is generally characterized by high ratios of glycine, alanine, serine, and tyrosine. Silk fibroin can exemplify a silk fibroin derived from an organism classified into the orders of Lepidoptera, Hymenoptera, or Araneae. In addition, it may also be silk fibroin obtained via gene recombination technology.

In addition, additives may be added to silk fibroin to the extent that it does not impair its properties.

### Adjustment of the Bulk Density

If the bulk density is low, the tableting strength is low, and the tablet breaks up when loading it into a mold and easily scatters around, so it is necessary for the bulk density to be 0.70 g/cm³ or more, 0.90 g/cm³ or more, or 1.00 g/cm³ or more. On the other hand, if the bulk density is high, the surface transferability becomes bad during molding, so it is necessary for the bulk density to be less than 1.20 g/cm³ and desirably less than 1.10 g/cm³. Although there is no particular limitation on the method for adjusting the bulk density of silk fibroin, it is possible to exemplify a method for adjusting the bulk density by crushing and compressing the silk fibroin powder, or a method for obtaining a base material for molding by drying an aqueous solution of the silk fibroin before it is formed as a powder or after the powder is re-dissolved, temporarily preparing a porous silk fibroin body having a low bulk density and then compressing the porous body to the bulk density as desired.

The bulk density adjustment method of the former will be described.

Since the bulk density of silk fibroin decreases when the particle size is reduced by crushing, the bulk density can be adjusted by controlling the crushed particle size. A jet mill, a pin mill, a hammer mill or the like can be used for grinding. The bulk density of silk fibroin increases by compressing it. The bulk density can be adjusted by controlling the pressure during compression. A compression molding machine or a tableting machine can be used for compression.

Next, the bulk density adjustment method of the latter will be described.

There is no particular limitation for the method of dissolving silk fibroin in water. For example, since the solubility of silk fibroin in water is low, a method of dissolving silk fibroin in a highly concentrated aqueous solution of lithium bromide and then desalting the solution by dialysis can be exemplified to make aqueous silk fibroin solution.

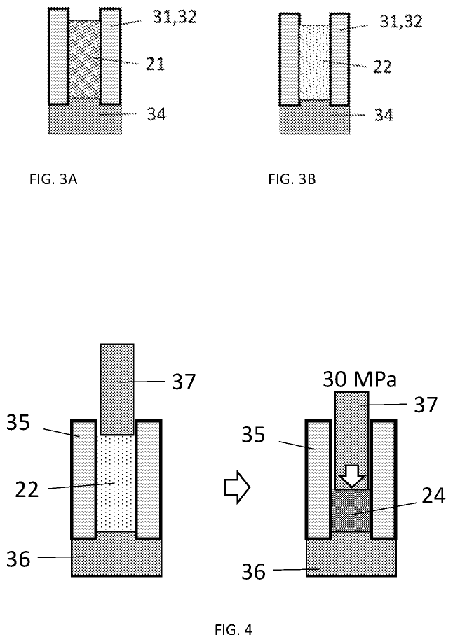

The method for drying the aqueous solution of silk fibroin is not particularly limited as long as the solvent can be removed without decomposing silk fibroin, and examples include air drying, heat drying, vacuum drying, spray drying, and lyophilization (freeze-drying), and the like. An advantage of lyophilization is that because the solution is frozen at a low temperature and the solvent is removed using sublimation, decomposition of the silk fibroin is suppressed. For instance, one method for molding silk fibroin comprises dispensing an aqueous solution of silk fibroin containing less than 10 g of silk fibroin, lyophilizing the solution, compressing the resulting lyophilized body until the bulk density becomes about 0.7 g/cm³ to about 1.20 g/cm³, and heating and pressurizing the compressed body. The process can utilize a block 31, 32 as shown in FIG. 2. Block 31 can be used to lyophilize one portion of aqueous fibroin solution, whereas block 32 can be used to simultaneously lyophilize multiple portions of aqueous silk fibroin solution. Through hole 33 in each of blocks 31, 32 is configured to receive the one or more portions of aqueous fibroin solution prior to freezing. Cross sections of blocks 31, 32 are provided in FIGS. 3A and 3B. In FIG. 3A, block 31, 32 contains through hole 33, into which aqueous silk fibroin solution 21 is introduced. Part 34 serves as a stopper on one end of through hole 33 to retain the aqueous silk fibroin solution within through hole 33. In FIG. 3B, lyophilization has occurred, resulting in lyophilized silk fibroin 22 which remains within the through hole 33 of blocks 31, 32. Part 34 is still present as a stopper at one end of through hole 33. FIG. 4 depicts a molding process for obtaining a base material for molding. Lyophilized silk fibroin 22 is loaded into a mold 35, having a through hole and a part 36 to maintain the loaded material within the through hole. The bulk density of the loaded material is adjusted by compressing the lyophilized silk fibroin 22 with a piston 37 to obtain the base material for molding 24. The pressure at the compression, can be, but is not limited to, for example, 30 MPa.

In addition to the bulk density, configurations for the base material for silk fibroin molding from the viewpoint of tablet hardness will be described. The tablet hardness of the base material for silk fibroin molding can be from 10 or more to 130 or less. If it is in this range, it is possible to obtain the effect of the present disclosure without scattering around upon loading into the mold and the surface transferability also becomes good. In additional embodiments, the tablet hardness of the base material for molding silk fibroin is from 20 or more to 120 or less, or from 30 or more to 115 or less.

In one embodiment, the moisture content after drying contains approximately 2 to 15% moisture content because this increases the fluidity during fibroin molding and improves the surface transferability.

Since surface transferability deteriorates when β-sheet formation is progressing after drying, in one embodiment the β-sheet ratio is less than 10%.

Furthermore, it is desirable that the solution is dried after being divided into a uniform amounts of liquid or divided into amounts of silk fibroin required for one molding or divided (dispensed) into amounts of silk fibroin equivalent to 1/N (N is an integer) in an aqueous solution, when drying it. Since it is generally more accurate to measure a liquid than to measure a powder, dividing the aqueous solution into fixed quantities and drying them, enables more accurate measuring than measuring after drying. For simplicity of weighing, N can typically be 2, 3, or 5 or less. And, silk fibroin weight in aqueous silk fibroin solution after dispensing can be approximately 10 g or less.

The base material for molding silk fibroin can be formed into a cylindrical, polygonal, spherical or hemispherical shape. This is because when obtaining the base material for silk fibroin molding by adjusting the bulk density by compression, pressure can be applied uniformly to the silk fibroin, and the hardness and the like of the base material for molding can be kept uniform within the base material for molding. If uniaxial compression is performed when obtaining base material for silk fibroin molding, the shape of the base material for molding can be cylindrical. When performing uniaxial compression, certain conditions provide that the height (thickness) of the base material for molding is 3 times or less and approximately 0.1 times or more of the diameter (or the width or the length) for uniform compression. In addition, the height (thickness) of the base material for silk fibroin molding can be 1 mm or more. This is because if the base material for silk fibroin molding is too thin, restrictions may arise for the shape after the molding that used the base material for the molding. The thickness of the base material can also be 1.5 mm or more, or 2.0 mm or more.

### Molding

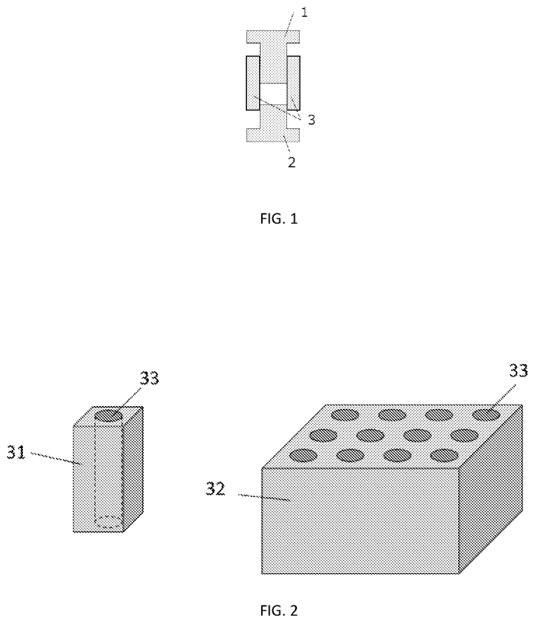

A silk fibroin molded body can be obtained by loading base material for silk fibroin molding of which the bulk density has been adjusted into a mold and heating and pressurizing it. FIG. 1 is a schematic diagram of an example of a mold that can be used for molding silk fibroin. The mold is composed of a part 3, of which the temperature can be adjusted, having a through-hole and an upper piston 1 and a lower piston 2, and the silk fibroin molded body can be obtained by loading the base material for silk fibroin molding into part 3 and compressing it by moving pistons 1 and 2 up and down.

The heating in the heating and pressurizing process can be carried out from 70° C. to 200° C., or from 100° C. to 150° C. At less than 70° C., the protein does not sufficiently integrate, so the molded body does not become strong enough. On the other hand, at 200° C. or higher, there is a concern that the protein may begin to decompose and the strength may decrease. Pressurization can be performed at 10 MPa or higher. At 10 MPa or lower, the protein does not sufficiently integrate, so the molded body will not be strong enough. Pressurization can also be performed at 50 MPa or higher.

In addition, the time for maintaining the pressure after the predetermined pressure is reached can be from 0 minutes to 60 minutes, or from 10 minutes to 30 minutes. And, after being taken out from the mold, heat treatment may be performed from 70° C. to 150° C. The heat treatment promotes crystallization and improves strength and shape stability.

### Measuring Method

Hereinafter, a measurement method necessary for the present disclosure will be described.

Bulk density was measured by the beads substitution method. Specifically, quartz sand (0.3~0.5 mm) of which the weight was measured in advance was put into a volume surveying instrument, and then silk fibroin was loaded into the surveying instrument, and the bulk density was estimated from the increase in the weight and volume of the surveying instrument.

The hardness of a prepared tablet was measured using a load cell type tablet hardness tester (PC-30, Okada Seiko Co., Ltd.).

The β-sheet ratio was measured using FT-IR (Frontier MIR NIR/Spotlight 400, Perkin Elmer). The absorbance was measured in the range from 1500 to 1800 cm⁻¹ and the peak wavelength N at 1600~ 1650 cm⁻¹ was read out, and the β-sheet ratio was calculated with the calculation formula of Equation 1.

$$β - sheet ratio ( \% ) = \frac{1641 - N}{20} \times 100 \qquad Equation 1$$

To use Equation 1 is because the peak wavelength is 1641 cm⁻¹ in the amorphous state and becomes 1621 cm⁻¹ in the fully crystallization state.

The flexural modulus was measured using an Instron universal testing machine (Model 5582, Instron). The distance between the fulcrums of three-point bending was fixed at 27 mm, and the measurement speed was set at 1 mm/min. The flexural modulus was determined from the displacement (strain) of 0.05 up to 0.25%.

The surface roughness was measured using a surface roughness meter (SurfCorder SE3500, Kosaka Laboratory Co., Ltd.), and the ten-point average roughness Rzjis was measured in accordance with JIS B 0601-1994.

### EXAMPLES

### Example 1

Silkworm cocoons were washed with water and then boiled in a 0.02 mol/L sodium carbonate aqueous solution for 30 minutes to degum cocoons. After drying, the degummed silk fibroin was put into a 9.3 mol/L LiBr aqueous solution and dissolved by agitating it at 60° C. for 4 hours. Dialysis flask30/32 (molecular weight cut off of 12000~ 14000) manufactured by Sekisui Chemical Co., Ltd. were used for desalination. The concentration of the fibroin aqueous solution after desalination was diluted with pure water so it became 5%.

The obtained 5% fibroin aqueous solution was divided into portions of 26.4 ml each into containers, as shown in FIG. 2. In FIG. 2, the reference numerals 31 and 32 each denote blocks for lyophilization to be performed later. Reference numeral 33 denotes a hole through which an aqueous solution of silk fibroin is injected.

The dispensed fibroin solution was lyophilized using the freeze dryer (FD-550P) manufactured by Tokyo Rikakikai Co., Ltd. (FIG. 3). FIGS. 3A and 3B respectively show cross sections of the blocks for lyophilization shown in FIG. 2. Reference numeral 21 denotes an aqueous solution of silk fibroin before lyophilization, and reference numeral 22 denotes lyophilized silk fibroin. In addition, reference numeral 34 denotes a part for holding the fibroin solution in place. In the lyophilization condition, after freezing at −30° C., the atmosphere was depressurized, and then the temperature was raised to −6° C., and lyophilization was conducted for 100 hours. When the bulk density was measured, it was 0.03 g/cm³.

Next, 1 piece of the silk fibroin, which was divided into small portions and lyophilized, was loaded into a mold having a 5 mm diameter cylindrical through-hole, pressurized at 30 MPa at 25° C., and then taken out to obtain a base material for molding (FIG. 4). In FIG. 4, reference numerals 35 and 36 denote molds for obtaining base material for molding. Reference numeral 37 denotes a piston for compression. In addition, reference numeral 24 denotes a base material for molding of silk fibroin obtained through this process. The same molds as the blocks 31, 32, and 34 for lyophilization may be used as the molds for obtaining the base material for molding.

When the bulk density of the obtained base material for molding was measured, it was 1.02 g/cm³. Measuring the β-sheet formation rate, it was 5%. Measuring the moisture content, it was 7%. When the tablet hardness was measured, it was 103 N, and a base material for molding having a good hardness that did not disintegrate even when held with tweezers or the like was obtained. A plurality of the base material for molding thus obtained may be stored together in a package and transferred to the main molding process. The package may be paper, resin, rubber, metal, or the like.

Subsequently, the base material for molding was molded by heating and pressurizing. A mold having a square columnar through-hole with a length of 35 mm and a width of 15 mm was used. A piston having a surface roughness Rz of 0.2 μm was used. The base material for molding was loaded into a mold of which the temperature had been adjusted to 125° C. in advance, pressurized with a pressure of 100 MPa for 30 seconds, and allowed to cool until the mold reached 25° C. When the silk fibroin molded body was taken out from the mold and the surface roughness of the surface contacted by the piston was measured, it was 2.3 μm, and good surface transfer was achieved.

### Example 2

A base material for molding silk fibroin was obtained with the same operation as Example 1, except that the lyophilized silk fibroin was pressurized at 20 MPa. When the bulk density of the obtained base material for molding was measured, it was 0.72 g/cm³. When the β-sheet ratio was measured, it was 5%. When the moisture content was measured, it was 7%. When the tablet hardness was measured, it was 34 N, and a base material for molding having a good hardness that did not disintegrate even when held with tweezers or the like was obtained.

A silk fibroin molded body was obtained with the same operation as in Example 1. When the surface roughness was measured, it was 2.2 μm, and good surface transfer was achieved.

### Comparative Example A

A base material for molding silk fibroin was obtained with the same operation as Example 1, except that the lyophilized silk fibroin was pressurized at 2 MPa. When the bulk density of the obtained base material for molding was measured, it was 0.50 g/cm³. When the β-sheet formation rate was measured, it was 5%. When the moisture content was measured, it was 7%. When the tablet hardness was measured, it was 10 N or less. In addition, when it was held with tweezers, it broke into many pieces, so the handling performance was poor.

The disintegrated fragments were collected and a silk fibroin molded body was obtained with the same operation as in Example 1. When the surface roughness was measured, it was 2.3 μm, and good surface transfer was achieved.

### Example 3

A base material for molding silk fibroin was obtained with the same operation as Example 1, except that the lyophilized silk fibroin was pressurized at 80 MPa. When the bulk density of the obtained base material for molding was measured, it was 1.20 g/cm³. When the β-sheet formation rate was measured, it was 5%. When the moisture content was measured, it was 7%. When the tablet hardness was measured, it was 114 N, and a base material for molding having a good hardness that did not disintegrate even when held with tweezers or the like was obtained.

A silk fibroin molded body was obtained with the same operation as in Example 1. When the surface roughness was measured, it was 2.3 μm, and good surface transfer was achieved.

### Comparative Example B

A base material for molding silk fibroin was obtained with the same operation as Example 1, except that the lyophilized silk fibroin was pressurized at 120 MPa. When the bulk density of the obtained base material for molding was measured, it was 1.28 g/cm³. When the β-sheet formation rate was measured, it was 5%. When the moisture content was measured, it was 7%. When the tablet hardness was measured, it was 132 N, and a base material for molding having a good hardness that did not disintegrate even when held with tweezers or the like was obtained.

A silk fibroin molded body was obtained with the same operation as in Example 1. When the surface roughness was measured, it was 17.2 μm. It is thought that surface transfer did not take place sufficiently, because the bulk specific gravity of the base material for molding became high, and it became hard.

### Example 4

The lyophilized silk fibroin was kept in an environment at 100° C. for 4 minutes, and then left at 23° C. with a relative humidity of 50% for 48 hours. Thereafter, the base material for silk fibroin molding was obtained with the same operation as in Example 1, except that it was pressurized at 20 MPa. When the bulk density of the obtained base material for molding was measured, it was 1.03 g/cm³. When the β-sheet formation rate was measured, it was 8%. When the moisture content was measured, it was 7%. When the tablet hardness was measured, it was 95 N, and a base material for molding having a good hardness that did not disintegrate even when held with tweezers or the like was obtained.

A silk fibroin molded body was obtained with the same operation as in Example 1. When the surface roughness was measured, it was 2.3 μm, and good surface transfer was achieved.

### Example 5

The lyophilized silk fibroin was kept in an environment at 90° C. for 3 minutes, and then left at 23° C. with a relative humidity of 50% for 30 minutes. Thereafter, the base material for silk fibroin molding was obtained with the same operation as in Example 1, except that it was pressurized at 20 MPa. When the bulk density of the obtained base material for molding was measured, it was 1.09 g/cm³. When the β-sheet formation rate was measured, it was 5%. When the moisture content was measured, it was 2%. When the tablet hardness was measured, it was 75 N, and a base material for molding having a good hardness that did not disintegrate even when held with tweezers or the like was obtained.

A silk fibroin molded body was obtained with the same operation as in Example 1. When the surface roughness was measured, it was 2.3 μm, and good surface transfer was achieved.

### Example 6

The lyophilized silk fibroin was left at 23° C. with a relative humidity of 80% for 12 hours. Thereafter, the base material for silk fibroin molding was obtained with the same operation as in Example 1, except that it was pressurized at 20 MPa. When the bulk density of the obtained base material for molding was measured, it was 1.12 g/cm³. When the β-sheet formation rate was measured, it was 5%. When the moisture content was measured, it was 15%. When the tablet hardness was measured, it was 89 N, and a base material for molding having a good hardness that did not disintegrate even when held with tweezers or the like was obtained.

A silk fibroin molded body was obtained with the same operation as in Example 1. When the surface roughness was measured, it was 2.4 μm, and good surface transfer was achieved.

### Example 7

A base material for silk fibroin molding was obtained with the same operation as in Example 4, except that keeping it in an environment of 100° C. for 4 minutes was changed to keeping it in an environment of 100° C. for 7 minutes. When the bulk density of the obtained base material for molding was measured, it was 1.02 g/cm³. When the β-sheet formation rate was measured, it was 13%. When the moisture content was measured, it was 7%. When the tablet hardness was measured, it was 68 N, and deformation was observed when the tablet was strongly pinched by the tweezers, but a base material for molding of a hardness which did not disintegrate was obtained.

A silk fibroin molded body was obtained with the same operation as in Example 1. When the surface roughness was measured, it was 2.9 μm, and good surface transfer was achieved.

### Example 8

A base material for silk fibroin molding was obtained with the same operation as in Example 5, except that the keeping it in an environment of 90° C. for 3 minutes was changed to keeping it in an environment of 90° C. for 5 minutes. When the bulk density of the obtained base material for molding was measured, it was 1.04 g/cm³. When the β-sheet formation rate was measured, it was 5%. When the moisture content was measured, it was 1%. When the tablet hardness was measured, it was 47 N, and deformation was observed when the tablet was strongly pinched by the tweezers, but a base material for molding of a hardness which did not disintegrate was obtained.

A silk fibroin molded body was obtained with the same operation as in Example 1. When the surface roughness was measured, it was 4.2 μm, and good surface transfer was achieved.

### Example 9

The lyophilized silk fibroin was left at 23° C. with a relative humidity of 80% for 24 hours. Thereafter, the base material for silk fibroin molding was obtained with the same operation as in Example 1, except that it was pressurized at 20 MPa. When the bulk density of the obtained base material for molding was measured, it was 1.02 g/cm³. When the β-sheet formation rate was measured, it was 5%. When the moisture content was measured, it was 17%. When the tablet hardness was measured, it was 41 N, and a base material for molding having a good hardness that did not disintegrate even when held with tweezers or the like was obtained.

A silk fibroin molded body was obtained with the same operation as in Example 1. When the surface roughness was measured, it was 3.6 μm, and good surface transfer was achieved. The results of the Examples and Comparative Examples are summarized in Table 1A and 1B, where X=poor, Δ=fair, O=good, and ⊚=very good.

TABLE 1A

| | Example | Example | Example | Example | Example | Example |
|---|---|---|---|---|---|---|
| | 1 | 2 | 3 | 4 | 5 | 6 |
| Bulk Density | 1.02 | 0.72 | 1.20 | 1.03 | 1.09 | 1.12 |
| (g/cm³) | | | | | | |
| β-sheet ratio | 5 | 5 | 5 | 8 | 5 | 5 |
| Moisture | 7 | 7 | 7 | 7 | 2 | 15 |
| content | | | | | | |
| Tablet | 103 | 34 | 114 | 95 | 75 | 89 |
| Hardness | ◯ | ◯ | ◯ | ◯ | ◯ | ◯ |
| (N) | | | | | | |
| Rz (μm) | 2.3 | 2.2 | 2.3 | 2.3 | 2.3 | 2.4 |
| Surface | ◯ | ◯ | ◯ | ◯ | ◯ | ◯ |
| transferability | | | | | | |

TABLE 1B

| | Example | Example | Example | Comparative | Comparative |
|---|---|---|---|---|---|
| | 7 | 8 | 9 | Example A | Example B |
| Bulk Density | 1.02 | 1.04 | 1.02 | 0.50 | 1.28 |
| (g/cm³) | | | | | |
| β-sheet ratio | 13 | 5 | 5 | 5 | 5 |
| Moisture | 7 | 1 | 17 | 7 | 2 |
| content | | | | | |
| Tablet | 68 | 47 | 41 | <10 | 132 |
| Hardness | ◯ | ◯ | ◯ | X | ⊚ |
| (N) | | | | | |
| Rz (μm) | 2.9 | 4.2 | 3.6 | 2.3 | 17.2 |
| Surface | Δ | Δ | Δ | ◯ | X |
| transferability | | | | | |

1. A base material for molding having silk fibroin as the main component, wherein the base material for molding has a bulk density of about 0.70 g/cm³ to 1.20 g/cm³.

2. The base material for molding according to claim 1, wherein the base material has a thickness of 1 mm or more.

3. The base material for molding according to claim 1 wherein the base material has a β-sheet ratio of less than 10%.

4. The base material for molding according to claim 1, wherein the base material has a moisture content of from about 2 to about 15%.

5. The base material for molding according to claim 1, wherein the base material has a cylindrical shape, a polygonal columnar shape, a spherical shape, or a hemispherical shape.

6. A base material for molding having silk fibroin as the main component, wherein the base material for molding has a tablet hardness of between 10 or more and 130 or less.

7. The base material for molding according to claim 6, wherein the tablet hardness is between 30 or more and 115 or less.

8. The base material for molding according to claim 6, wherein the base material has a thickness of 1 mm or more.

9. The base material for molding according to claim 6, wherein base material has a β-sheet ratio of less than 10%.

10. The base material for molding according to claim 6, wherein the base material has a moisture content of from 2 to 15%.

11. The base material for molding according to claim 6, wherein the base material has a cylindrical shape, a polygonal columnar shape, a spherical shape, or a hemispherical shape.

12. A method for producing a base material for silk fibroin molding comprising the steps of:
lyophilizing an aqueous solution of silk fibroin; and
compressing the lyophilized material until its bulk density becomes 0.7 g/cm³~1.2 g/cm³.

13. The method for producing the base material for silk fibroin molding according to claim 12, wherein the lyophilization is conducted using an aqueous solution of silk fibroin that has been dispensed so that the solid content concentration becomes 10 g or less.

14. A molding method comprising:
setting a base material for molding containing silk fibroin having an bulk density of 0.70 g/cm³ to 1.20 g/cm³ as its main component into a mold; and
obtaining a silk fibroin molded body by heating and pressurizing the base material for molding.
